(19) United States
(12) Patent Application Publication
(10) Pub. No.: US 2015/0149296 A1
(43) Pub. Date: May 28, 2015

(54) TARGETED CONTENT FOR ULTIMATE FANS

(71) Applicants: Ryan Melcher, Ben Lomond, CA (US); John Richard Tapley, San Jose, CA (US); Scott Leach, Pleasanton, CA (US)

(72) Inventors: Ryan Melcher, Ben Lomond, CA (US); John Richard Tapley, San Jose, CA (US); Scott Leach, Pleasanton, CA (US)

(21) Appl. No.: 14/091,079

(22) Filed: Nov. 26, 2013

(51) Int. Cl. G06Q 30/02

(52) U.S. Cl. CPC G06Q 30/0269
USPC 705/14.66

(57) ABSTRACT

Methods and systems for providing targeted content to a user, such as an ultimate fan, are described. A user is able to attend a current event and have behavior information associated with the current event collected. Based on the behavior information, the user can be identified as an ultimate fan. Once the user is identified as an ultimate fan, targeted content can be delivered to the user. Targeted content includes discounts, promotions, marketing offers, and advertisements.

### BACKGROUND

1. Field of the Invention

The present invention generally relates to providing targeted content to fans in the sports, music, and entertainment industry.

2. Related Art

Fans at sports games, concerts, and other live entertainment events often wear clothes and perform actions that demonstrate loyalty and support for their favorite teams. For example, they will sing, dance, chant, and otherwise make noise during the event. Fanatics of sports teams wave towels, banners, and flags, applaud, cheer, and boo during a game. Ardent fans at a music concert clap, sing, and dance to show appreciation for the performer.

It would be beneficial to deliver targeted content, e.g., discounts, promotions, cash-backs, marketing offers, advertisements, etc. to reward fans and to promote loyalty in fans.

### BRIEF DESCRIPTION OF THE FIGURES

FIG. 1 is a is a block diagram of a networked system suitable for implementing the methods described herein according to an embodiment of the present disclosure;

FIG. 2 is a block diagram of a computer system suitable for implementing one or more components in FIG. 1 according to one embodiment of the present disclosure; and

FIG. 3 is a flowchart showing a method of providing targeted content to a user according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for tracking and analyzing information collected from a user device, e.g., location and associated activity, and providing targeted content to the user's device based on the information. For example, a user may be determined to be at a football game and cheering for a specific team. The information collected may include pictures that the user takes of himself or herself wearing the team's jersey, a specific chant or shout associated with the football team, previous ticket purchases or attendance for the same team, and the location of the game relative to a user's home location. All these details contribute to the determination that the user is at a football game and is a fan of a specific team. If the user is determined to be an ultimate fan, targeted content, e.g., promotional information and advertisements, can then be sent to the user's device. Such targeted content can include discounted tickets to the next football game or discounts on team merchandise at the event venue.

An “ultimate fan” is a person who is extreme in their enthusiastic devotion to something, such as a sports team, band, or entertainer. For example, a regular fan may watch a TV show (e.g., The Office) on a regular basis. An ultimate fan, on the other hand, may record all the episodes, watch them repeatedly, and memorize all the lines in the different episodes.

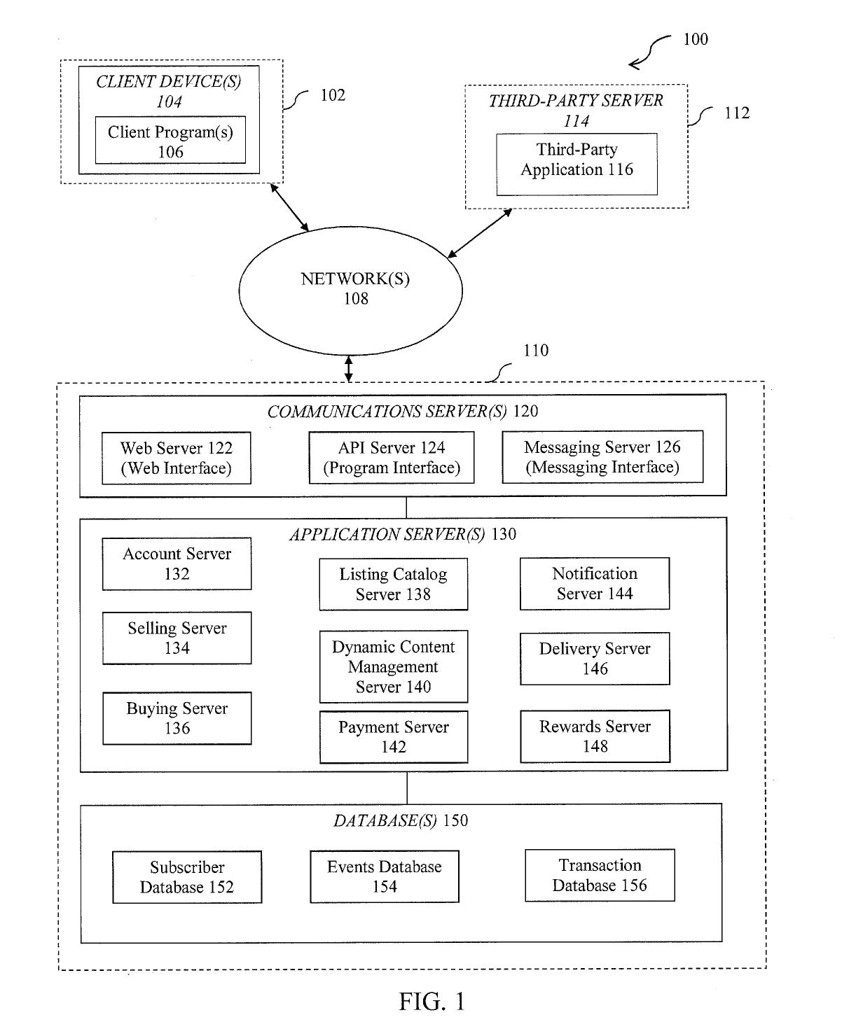

Beginning with FIG. 1, an exemplary embodiment of a computing system adapted for implementing one or more processes involving providing targeted content to fans is illustrated in block diagram format. As shown, computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a user 102 that may comprise or employ one or more user devices 104, such as a mobile computing device, a wearable computing device such as a smartwatch, a PC, and/or any other computing device having computing and/or communications capabilities in accordance with the described embodiments. User devices 104 generally may provide one or more user programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of user programs 106 may display various graphical user interfaces (GUIs) to present information to and/or receive information from one or more of user devices 104.

User device 104 may include one or more of a motion sensor, an image sensor (e.g. camera), a voice sensor (e.g. microphone), an optical sensor, and any other kind of device suitable to collect information regarding a user. Motion sensors such as motion detectors, accelerometers and/or gyroscopes may monitor speed, acceleration, position, rotation, and other characteristics of body and appendage motion. The motion sensor captures movement of a user, such as a pose, position, or gesture. Example gestures include for instance, an “air quote” gesture, a bowing gesture, a curtsey, a cheek-kiss, a finger or hand motion, a head bobble or movement, a high-five, a nod, a raised fist, a salute, a swiping or wave motion, a thumbs-up motion, a hand-moving-in-circle or hand waving gesture, or a finger pointing gesture. An image sensor captures images of the user. A voice sensor captures the voice or sounds made by the user. An optical sensor captures and characterizes light. Information captured by the sensors may be collected, stored, and associated with a specific user.

User device 104, in one embodiment, includes a geo-location component adapted to monitor and provide an instant geographical location (i.e., geo-location) of the user device 104. In one implementation, the geo-location of the user device 104 may include global positioning system (GPS) coordinates, zip-code information, area-code information, street address information, and/or various other generally known types of geo-location information. In one example, the geo-location information may be directly entered into the user device 104 by a user via a user input component, such as a keyboard, touch display, and/or voice recognition microphone. In another example, the geo-location information may be automatically obtained and/or provided by the user device 104 via an internal or external GPS monitoring component. In other embodiments, the geo-location can be automatically obtained without the use of GPS. In some instances, cell signals or wireless signals are used. This helps to save battery life and to allow for better indoor location where GPS typically does not work.

In one aspect, when interfacing with the user device 104, the user 102 may elect to provide or may be prompted to provide permission for the release of geo-location information. Accordingly, the user 102 may have exclusive authority to allow transmission of geo-location information from the user device 104 to the network-based system 110. In any instance, the network-based system 110 may communicate with the user device 104 via the network 108 and request permission to acquire geo-location information from the user device 104 for geo-location based mobile commerce.

As shown, user 102 can be communicatively coupled via one or more networks 108 to a network-based system 110 managed by an online service provider, such as, for example, StubHub, Inc. of San Francisco, Calif. Network-based system 110 may be structured, arranged, and/or configured to allow user 102 to establish one or more communication sessions with network-based system 110 using various computing devices 104 and/or user programs 106. Accordingly, a communication session between user 102 and network-based system 110 may involve the unidirectional and/or bidirectional exchange of information and may occur over one or more types of networks 108 depending on the mode of communication. While the embodiment of FIG. 1 illustrates a computing system 100 deployed in a user-server operating environment, it is to be understood that other suitable operating environments and/or architectures may be used in accordance with the described embodiments.

Data and/or voice communications between user 102 and the network-based system 110 may be sent and received over one or more networks 108 such as the Internet, a WAN, a WWAN, a WLAN, a mobile telephone network, a landline telephone network, a VoIP network, as well as other suitable networks. For example, user 102 may communicate with network-based system 110 over the Internet or other suitable WAN by sending and or receiving information via interaction with a web site, e-mail, IM session, and/or video messaging session. Any of a wide variety of suitable communication types between user 102 and system 110 can take place, as will be readily appreciated.

In various embodiments, computing system 100 can include, among other elements, a third party 112, which may comprise or employ a third-party server 114 hosting a third-party application 116. In various implementations, third-party server 114 and/or third-party application 116 may host a web site associated with or employed by a third party 112. For example, third-party server 114 and/or third-party application 116 may enable network-based system 110 to provide user 102 with additional services and/or information, such as additional ticket inventory. In some embodiments, one or more of user programs 106 may be used to access network-based system 110 via third party 112. For example, user 102 may use a web user to access and/or receive content from network-based system 110 after initially communicating with a web site of third-party 112.

Network-based system 110 may comprise one or more communication servers 120 to provide suitable interfaces that enable communication using various modes of communication and/or via one or more networks 108. Communication servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, user 102 may communicate with application servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of user devices 104 and/or user programs 106 and may interoperate with each other in some implementations.

Web server 122 may be arranged to communicate with web users and/or applications such as a web browser, web browser toolbar, desktop widget, mobile widget, web-based application, web-based interpreter, virtual machine, and so forth. API server 124 may be arranged to communicate with various user programs 106 and/or a third-party application 116 comprising an implementation of API for network-based system 110. Messaging server 126 may be arranged to communicate with various messaging users and/or applications such as e-mail, IM, SMS, MMS, telephone, VoIP, video messaging, and so forth, and messaging server 126 may provide a messaging interface to enable access by user 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, and notification services. Application servers 130 may include an account server 132, a buying server 134, a selling server 136, a listing catalog server 138, a dynamic content management server 140, a payment server 142, a notification server 144, and/or a delivery server 146 structured and arranged to provide such online marketplace and ticket fulfillment services. Application servers 130 are adapted to receive and collect information from a user at an event, identify the event, compare the received information with information with a known event, determine whether or not a user is an ultimate fan, and provide targeted content to the user based on the event. The targeted content can include advertisements, special promotional offers, discounted tickets, event information, etc. In various embodiments, when a user decides to avail of the targeted content, application servers 130 receive the user request and process any payment associated with the request.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

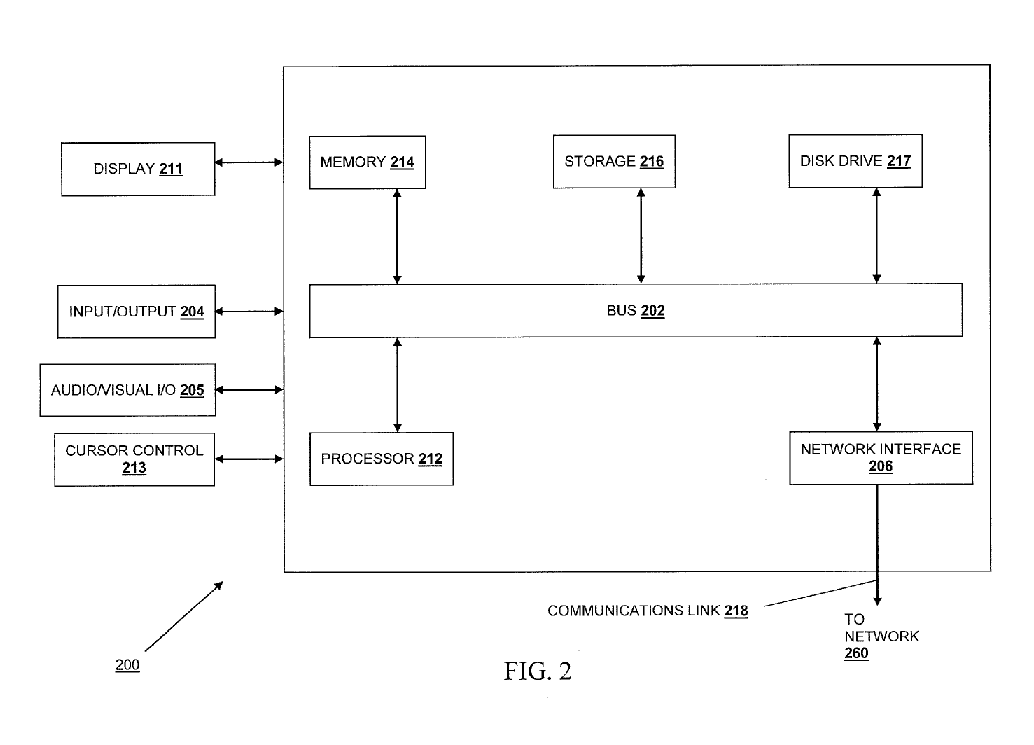

Continuing with FIG. 2, an exemplary computer system 200 suitable for implementing one or more devices of the computing system in FIG. 1 is depicted in block diagram format. In various implementations, a device that includes computer system 200 may comprise a personal computing device (e.g., a smartphone, a computing tablet, a personal computer, laptop, PDA, Bluetooth device, key FOB, badge, etc.) that is capable of communicating with a network. The service provider may utilize a network computing device (e.g., a network server) capable of communicating with the network. It should be appreciated that each of the devices utilized by users and service providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, or a payment provider server via a network. In one embodiment, the transmission is wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise.

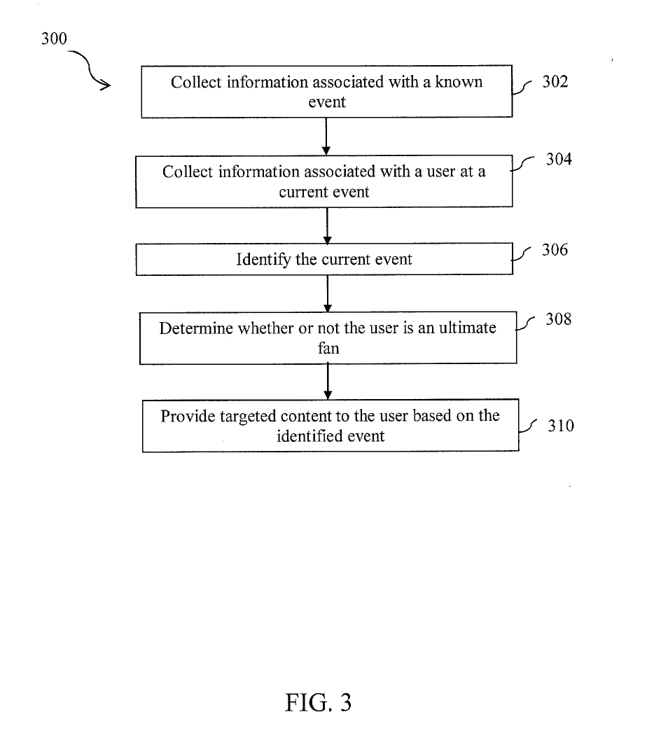

Referring now to FIG. 3, a flowchart of a method 300 for providing targeted content to a user, such as a fan, is illustrated according to an embodiment of the present disclosure. It should be appreciated that the method illustrated in the embodiment of FIG. 3 may be implemented by the systems illustrated in FIGS. 1 and/or 2 according to one or more embodiments.

The method 300 begins at step 302, in which information associated with a known event is compiled or collected and stored. The information should be information that identifies the event. The information may include behavior information at sporting events, concerts, plays, festivals, shows, meetings, conferences, fairs, forums, etc. For example, typical fan behavior at a sporting event may include dressing in a costume, putting on face paint, chanting, shouting, jumping, hand motions (e.g., waving the Terrible Towel for the Pittsburgh Steelers, high-fiving adjacent fans when a team does something good, etc.), singing a certain song (e.g., the Tomahawk Chop Song for the Atlanta Braves, the Ohio State fight song, Sweet Caroline at a Boston Red Sox game, etc.), making noise when the opposing team tries to score, doing the wave, and taking and sharing pictures, videos, and comments on social media sites. Behavior at a music concert may include singing (e.g., singing the lyrics to Vogue at a Madonna concert), dancing, swaying, screaming, clapping, head bopping, and hand waving. The information may also include contextual information of the event. Contextual information includes location, date, time, weather, how many people are at the event, and any other information that can be used to determine the identity of an event. Step 302 may be done in any suitable manner, including by observing activities of fans at different events through a device of the fan, other fans, and/or the event venue, and inputting those activities into a database.

In step 304, information associated with the user 102 at a current event is collected through the user device 104. Behavior and context information can be obtained, for example, by receiving information output by a sensor or multiple sensors coupled to the user device 104. The user device 104 is exposed to the ambient environment that user 102 is currently experiencing. In various embodiments, the user 102 can log in to an application, and information is collected only after the user 102 checks in. In other embodiments, the user 102 can configure the application to automatically start collecting information once the user 102 is at a certain location. The information regarding the user 102 may be collected in much the same way as described above in step 202. Note that information may be collected through devices associated with others, such as other fans, television cameras, event venue cameras, etc.

In an exemplary embodiment, the information is collected using a wearable computing device, such as a smartwatch. Using a smartwatch enhances the user experience since the user 102 does not need to physically hold on to a device, and has more freedom of movement. That is, his or her hands are free to clap and hold fan memorabilia.

Based on the information collected in step 304, the current event is identified at step 306. The event may be identified based on the details of the event, such as what the event is about (e.g., sports game, theater performance, musical) and who is present or performing (e.g., what team, what band, what actors/actresses). In one example, the user 102 provides information associated with the event by inputting the name of the performer or sports team, the location of the event, and other event details in the user device 104.

In another example, the collected information in step 304 is compared to the known information in step 302. In other words, the collected information is compared to data predetermined to match one or more events. Several predetermined data corresponding to different specific events (e.g., a concert, a musical, a sporting event) may be used to perform a comparison with collected information, thus determining whether or not the user is in the same situation. Different performers, venues, or sports teams may be recognized by comparing contexts and user behaviors.

Based on this comparison, similarities may be detected between the two events, and a determination made as to the current event. This comparison may be carried out in any suitable manner. For instance, information received from one sensor may be enough to determine that the user 102 is currently at a specific event. In another example, multiple sensors may be needed.

In one embodiment, a probability that the user 102 is at a specific event is determined. The probability may be a numerical value (e.g., 0.2 out of a range of values between 0 and 1) or may be a qualitative description (e.g., “low” or “high”). In some embodiments, a determination of whether the probability exceeds or crosses a certain threshold is made. The threshold may be associated with the level of certainty that the user 102 is at a specific event. If the probability exceeds the threshold, the user 102 may be determined to be within the specific event.

If the probability does not exceed the threshold, other information may be gathered from other sensors, e.g., sensors on the user device 104. Other sensors may include local sensors, i.e., co-located within the user device 104, such as a motion sensor to determine movement, an audio sensor to determine sound, an accelerometer to sense the direction of gravity and any other linear force experienced by the user, a temperature sensor to determine temperature, and a humidity sensor to determine humidity. The other sensors may also include non-local sensors, i.e., sensors not co-located on the user device 104, such as sensors to determine calendar appointments or email messages. Based on the information output by the other sensors, another probability associated with the determination that the user is at a specific event may be calculated. The event the user is attending may also be determined by determining the location of the user (such as through location services from the user device) and matching that location to known events at that location for the specific day or time. For example, the user may be determined to be at Dodger Stadium on Nov. 17, 2013 and there are no games scheduled at Dodger Stadium that day, but there is an Eagles concert scheduled for that day, the user may be determined to be at an Eagles concert.

At step 308, whether or not the user is an ultimate fan is determined based on the information collected. In various embodiments, the user 102 is provided better incentives and rewards if he or she exhibits fanatic behavior. For example, an ultimate sports fan may attend every single game their team plays, paint his or her face the team colors, be very active during the game such as yell, high five, hug, and/or jump often during the event as opposed to a fan that sits in the seat the whole time, perform specific gestures associated with the team (such as a chop, “Hook'em Horns” gesture, etc.), and buy tons of merchandise with their team logo. This ultimate fan may receive higher discounts and better rewards than an ordinary fan that does not show as much enthusiasm or loyalty to their team.

For example, an ultimate fan can be provided real-time incentives that are not available to an ordinary fan, e.g., free food or merchandise during a game, opportunities to meet and take pictures with their favorite player, a chance to visit the locker room, etc. An ultimate fan may be identified by the number of times or how long the user engages in a certain behavior (e.g., yelling, singing, dancing, jumping, clapping or high-fiving), the number of pictures and videos that he or she takes, or the number of tweets he or she posts during an event. The criteria for identifying an ultimate fan may be determined and set in a wide variety of ways. In some embodiments, the behavior of the fan during the event can be combined with information regarding purchases the fan has made, such as tickets, albums, t-shirts, and other relevant paraphernalia. In one embodiment, a checklist of behavior and items purchased may be prepared, and a fan recognized as an ultimate fan only if he or she can check off all the items on the list.

Once a fan is categorized as an ultimate fan for a specific sports team, music band, or theatrical play, content that is related to that event may be communicated to the fan during the event. A fan may demonstrate fanatic behavior during a Los Angeles Lakes game, determined to be an ultimate fan of the Los Angeles Lakers, and be provided discounts to the Lakers jersey, for tickets to Lakers game, or for food during the Lakers game. This same fan, however, may not show fanatic behavior during a concert for Taylor Swift. Thus, he or she does not receive any discounts or offers during the concert.

At step 310, targeted content is provided to the user 102 based on the identified event. The targeted content may include incentives to the user 102 such as rewards, advertisements, discounts, prizes, promotional offers, coupons, loyalty points, early purchase opportunities, etc. The targeted content in one embodiment is content that, based on the identified event, the user 102 would be interested in. User interest may be based on previous purchases, identification of which team the user is a fan of, user home location relative to the event venue (user likely a fan of the “home” team), what the user is wearing, what the user says before or during the event, and/or how the user acts during certain times of the event.

For example, if the user 102 is determined to be at the HP Pavilion in San Jose, and user behavior demonstrates that the user 102 is at a San Jose Sharks game (e.g., wearing San Jose Sharks gear and screaming “Go Sharks!”), the targeted content may include a free hot dog, discounted concessions, discounted tickets, or early purchase opportunities to the next Sharks game. In contrast, if the user behavior demonstrates that the user 102 is at a Pearl Jam concert (e.g., wearing a Pearl Jam t-shirt and singing the lyrics to Better Man), the targeted content may include a promotion related to an upcoming Pearl Jam concert in the Bay Area, a free downloadable Pearl Jam track, free merchandise, and promotions for nearby locations (e.g., restaurants, sports facilities).

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A system, comprising:
one or more memory devices or storage components adapted to store information related to event information; and
one or more processors in communication with the one or more memory devices or storage components and adapted to:
receive, from a user device, information associated with behavior of a user at a current event;
determine whether or not the user is an ultimate fan based on the behavior information; and
provide targeted content to the user when the user is an ultimate fan, wherein the targeted content is related to the current event.

2. The system of claim 1, wherein the user device is a wearable computing device.

3. The system of claim 2, wherein the wearable computing device comprises a smartwatch.

4. The system of claim 1, wherein determining whether or not the user is an ultimate fan comprises combining the behavior information with user purchase information.

5. The system of claim 1, wherein determining whether or not the user is an ultimate fan comprises determining how long or how many times the user engages in a behavior.

6. The system of claim 1, wherein the behavior information comprises singing, dancing, chanting, posting pictures or videos, or combinations thereof.

7. The system of claim 1, wherein the targeted content comprises discount tickets, ticket promotions, marketing offers, advertisements, or combinations thereof.

8. The system of claim 7, wherein the one or more processors is further adapted to receive a request from the user for discounted tickets and process a payment associated with the request.

9. A method for providing targeted content to a user, comprising:
receiving, by one or more hardware processors of a service provider, information associated with behavior of a user at a current event from a user device;
determining whether or not the user is an ultimate fan based on the behavior information; and
providing targeted content to the user when the user is an ultimate fan, wherein the targeted content is related to the current event.

10. The method of claim 9, wherein the user device is a smartwatch.

11. The method of claim 9, wherein determining whether or not the user is an ultimate fan comprises combining the behavior information with user purchase information.

12. The method of claim 9, wherein determining whether or not the user is an ultimate fan comprises determining how long or how many times the user engages in a behavior.

13. The method of claim 9, wherein the behavior information comprises singing, dancing, chanting, posting pictures or videos, or combinations thereof.

14. The method of claim 9, wherein the targeted content comprises discount tickets, ticket promotions, marketing offers, advertisements, or combinations thereof.

15. A non-transitory machine-readable medium comprising a plurality of machine-readable instructions which, when executed by one or more processors, are adapted to cause the one or more processors to perform a method comprising:
receiving information associated with behavior of a user at a current event from a user device;
determining whether or not the user is an ultimate fan based on the behavior information; and
providing targeted content to the user, wherein the targeted content is related to the current event.

16. The non-transitory machine-readable medium of claim 15, wherein the user device is a smartwatch.

17. The non-transitory machine-readable medium of claim 15, wherein determining whether or not the user is an ultimate fan comprises combining the behavior information with user purchase information.

18. The non-transitory machine-readable medium of claim 15, wherein determining whether or not the user is an ultimate fan comprises determining how long or how many times the user engages in a behavior.

19. The non-transitory machine-readable medium of claim 18, wherein the behavior information comprises singing, dancing, chanting, posting pictures or videos, or combinations thereof.

20. The non-transitory machine-readable medium of claim 15, wherein the targeted content comprises discount tickets, ticket promotions, marketing offers, advertisements, or combinations thereof.
